(19) United States
(12) Patent Application Publication
(10) Pub. No.: US 2025/0144941 A1
(43) Pub. Date: May 8, 2025

(54) CIRCULATION DEVICE, PRINTING DEVICE, CIRCULATION METHOD, AND PRINTING METHOD

(71) Applicant: KYOCERA CORPORATION, Kyoto-shi, Kyoto (JP)

(72) Inventors: Naoki KOBAYASHI, Kirishima-shi, Kagoshima (JP); Kazuya YOSHIMURA, Kirishima-shi, Kagoshima (JP)

(21) Appl. No.: 18/839,023

(22) PCT Filed: Feb. 27, 2023
(86) PCT No.: PCT/JP2023/007157

§ 371 Date: Aug. 16, 2024

(30) Foreign Application Priority Data
Feb. 28, 2022 (JP) 2022-029983

(51) Int. Cl. B41J 2/18; B41J 2/21; B41J 11/00; B41J 29/00

(52) U.S. Cl. CPC B41J 2/18; B41J 2/2103; B41J 11/0015; B41J 29/00

(57) ABSTRACT

A circulation device according to an aspect includes an ink circulation unit that circulates ink via an ink head that discharges the ink, and a treatment liquid circulation unit that circulates a non-color-developing treatment liquid via a treatment liquid head that discharges the treatment liquid. In an embodiment, in the circulation device, a circulation flow rate of the ink in the ink circulation unit is different from a circulation flow rate of the treatment liquid in the treatment liquid circulation unit.

### CROSS-REFERENCE TO RELATED APPLICATIONS

This application is national stage application of International Application No. PCT/JP2023/007157, filed on Feb. 27, 2023, which designates the United States, and which claims the benefit of priority from Japanese Patent Application No. 2022-029983, filed on Feb. 28, 2022.

### TECHNICAL FIELD

Disclosed embodiments relate to a circulation device, a printing device, a circulation method, and a printing method.

### BACKGROUND OF INVENTION

Inkjet printers and inkjet plotters utilizing an inkjet recording method are known as printing devices. An ink head for discharging ink is mounted in such a printing device using an inkjet method.

In recent years, there has been proposed a technique of discharging a pre-treatment liquid onto a recording medium before discharging ink onto the recording medium. A technique has been proposed in which a post-treatment liquid is discharged onto a recording medium after discharging ink. The pre-treatment liquid is, for example, a treatment liquid for improving fixability of ink to a recording medium and an aggregation property of an ink pigment. The post-treatment liquid is, for example, a treatment liquid for enhancing fastness of a printed image. As described above, in recent years, a plurality of different types of liquids may be discharged onto a recording medium.

### CITATION LIST

### Patent Literature

Patent Document 1: JP 2017-094673 A

### SUMMARY

In an aspect of an embodiment, a circulation device includes an ink circulation unit configured to circulate ink via an ink head for discharging the ink, and a treatment liquid circulation unit configured to circulate non-color-developing treatment liquid via a treatment liquid head for discharging the treatment liquid. In the embodiment, in a circulation device, a circulation flow rate of the ink in the ink circulation unit is different from a circulation flow rate of the treatment liquid in the treatment liquid circulation unit.

### BRIEF DESCRIPTION OF THE DRAWINGS

FIG. 1 is a schematic view illustrating a configuration of a printing device according to an embodiment.

FIG. 2 is an explanatory diagram of a discharge procedure of ink, a pre-treatment liquid, and a post-treatment liquid.

FIG. 3 is an explanatory diagram of the discharge procedure of the ink, the pre-treatment liquid, and the post-treatment liquid.

FIG. 4 is an explanatory diagram of the discharge procedure of the ink, the pre-treatment liquid, and the post-treatment liquid.

FIG. 5 is a perspective view schematically illustrating an outer appearance configuration of an ink head according to the embodiment.

FIG. 6 is a plan view of the ink head according to the embodiment.

FIG. 7 is a diagram schematically illustrating a channel inside the ink head according to the embodiment.

FIG. 8 is a diagram schematically illustrating a configuration example of an element portion according to the embodiment.

FIG. 9 is a schematic view illustrating a configuration example of a circulation device according to the embodiment.

FIG. 10 is a schematic view illustrating a configuration example of an ink circulation unit according to the embodiment.

FIG. 11 is a table illustrating a drive voltage, an electrostatic capacitance, and a drive frequency of the element portion, a printing rate per unit image, and a heat generation amount ratio in each of the ink head, a pre-treatment liquid head, and a post-treatment liquid head.

FIG. 12 is a table illustrating a discharge amount per unit nozzle, a discharge amount per unit time, a target heat dissipation amount ratio, a discharge amount per unit time+a circulation flow rate, and a circulation flow rate in each of the ink head, the pre-treatment liquid head, and the post-treatment liquid head.

FIG. 13 is a block diagram illustrating a functional configuration of a controller according to another embodiment.

### DESCRIPTION OF EMBODIMENTS

Embodiments of a circulation device, a printing device, a circulation method, and a printing method disclosed in the present application will be described in detail below with reference to the accompanying drawings. The invention according to the present application is not limited by embodiments described below.

When a plurality of different types of liquids is discharged onto a recording medium, variation in temperature may occur among the liquids. Provision of a circulation device and a printing device capable of reducing variation in temperature among liquids is expected.

### Configuration Example of Printing Device

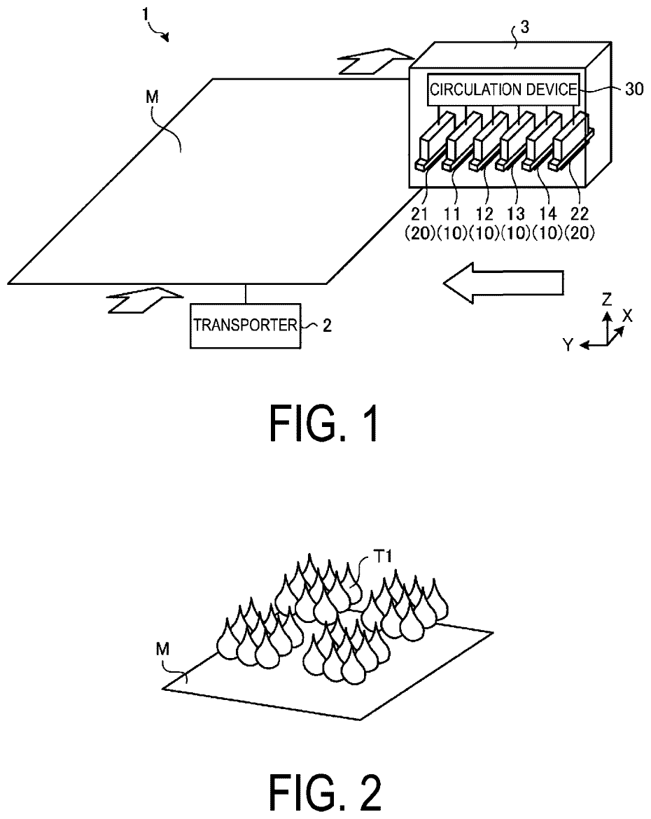

A configuration example of a printing device according to an embodiment will be described with reference to FIG. 1. FIG. 1 is a schematic view illustrating the configuration of the printing device according to the embodiment.

As illustrated in FIG. 1, in the embodiment, a printing device 1 performs printing on a recording medium M by an inkjet method. The recording medium M is, for example, cloth or paper. The printing device 1 includes a transporter 2 and a carriage 3.

The transporter 2 transports the recording medium M in a transport direction, here, an X-axis positive direction. For example, the transporter 2 may include a feeding roller feeding the recording medium M before printing and a winding roller winding the recording medium M after printing. A motor rotationally driving the winding roller around a shaft and causing the winding roller to perform winding operation of the recording medium M is attached to the winding roller. The transporter 2 may include a tension roller that applies tension to the recording medium M and a transport roller that generates transport force that intermittently feeds the recording medium M in a transport path between the feeding roller and the winding roller.

The carriage 3 is supported by a guide rail (not illustrated) extending along a scanning direction intersecting with the transport direction of the recording medium M. Here, the transport direction is the X-axis positive direction, and the scanning direction is a Y-axis positive direction. Note that the transport direction and the scanning direction may intersect with each other, and need not necessarily be orthogonal to each other. The carriage 3 reciprocates along the guide rail. That is, the carriage 3 can move in the Y-axis positive direction and in a Y-axis negative direction.

The printing device 1 includes a plurality of ink heads 10, a plurality of treatment liquid heads 20, and a circulation device 30. The ink head 10 discharges an ink for image formation onto the recording medium M. The treatment liquid head 20 discharges a non-color-developing treatment liquid (the treatment liquid may be called as a processing solution) onto the recording medium M. The circulation device 30 circulates the ink and the treatment liquid. The plurality of ink heads 10, the plurality of treatment liquid heads 20, and the circulation device 30 are disposed inside the carriage 3. Note that a part of the circulation device 30 may be disposed outside the carriage 3. For example, a tank or the like of the circulation device 30 may be disposed outside the carriage 3.

As an example, the printing device 1 includes a first ink head 11, a second ink head 12, a third ink head 13, and a fourth ink head 14, as the ink heads 10. The first to fourth ink heads 11 to 14 discharge inks of different colors, respectively. As an example, the first to fourth ink heads 11 to 14 discharge cyan, magenta, yellow, and black inks, respectively.

The printing device 1 includes a pre-treatment liquid head 21 and a post-treatment liquid head 22, as the treatment liquid heads 20.

The pre-treatment liquid head 21 discharges a pre-treatment liquid. The pre-treatment liquid is, for example, a treatment liquid that exhibits a function of improving fixability of the ink to the recording medium M and an aggregation property of a pigment contained in an ink pigment. As such a pre-treatment liquid, a treatment liquid in which a binding resin is blended in a solvent, a treatment liquid in which a cationic resin positively charged is blended in a solvent, or the like can be used.

The post-treatment liquid head 22 discharges a post-treatment liquid. The post-treatment liquid is a treatment liquid that exhibits a function of improving fixability and fastness of an ink image drawn on the recording medium M. The “fastness” referred to herein refers to resistance to rubbing and scraping. As such a post-treatment liquid, a silicone-based treatment liquid or the like can be used. Note that the post-treatment liquid and the pre-treatment liquid are different treatment liquids. Specifically, components contained in the post-treatment liquid are different from those contained in the pre-treatment liquid.

Here, the non-color-developing treatment liquid refers to a liquid that is not recognized by a person by the naked eye as having developed color when attached alone to the recording medium M. Here, the color includes a color having a saturation of 0, such as black, white, and gray. The non-color-developing treatment liquid is basically a transparent liquid, but for example, when one liter of the treatment liquid is viewed in a liquid state, the non-color-developing treatment liquid may not be completely transparent and may appear slightly white or the like. Since such a color is very light, a person cannot recognize that the color is developed by the naked eye when the color is printed alone on the recording medium M. Depending on the type of treatment liquid, when printed alone on the recording medium M, there may be changes in the recording medium such as a glossy appearance, but such a state is not considered to be color development.

The first to fourth ink heads 11 to 14, the pre-treatment liquid head 21, and the post-treatment liquid head 22 are arranged along the scanning direction (Y-axis positive direction) of the carriage 3. The pre-treatment liquid head 21 is disposed upstream of the first to fourth ink heads 11 to 14 in the scanning direction of the carriage 3, specifically, on the Y-axis positive direction side. The post-treatment liquid head 22 is disposed downstream of the first to fourth ink heads 11 to 14 in the scanning direction of the carriage 3, specifically, on the Y-axis negative direction side.

As an example, the printing device 1 performs a printing process on the recording medium M by a serial printing method. The serial printing method is a printing method in which movement of the carriage 3 along the scanning direction and intermittent feeding of the recording medium M in the transport direction are alternately repeated.

Specifically, the printing device 1 performs printing for one line on the recording medium M while moving the carriage 3 from an initial position in the Y-axis positive direction in a state in which feeding of the recording medium M is stopped. The initial position is a position on the Y-axis negative direction side of the recording medium M. “For one line” corresponds to “for a unit printing width”. When printing for one line is completed, the printing device 1 returns the carriage 3 to the initial position and feeds the recording medium M in the transport direction by one line. The printing device 1 prints a predetermined image on the recording medium M by repeating the series of operations.

With reference to FIG. 2 to FIG. 4, a discharge procedure of ink, a pre-treatment liquid, and a post-treatment liquid when an image for one line is printed will be described. FIG. 2 is an explanatory diagram of the discharge procedure of the ink, the pre-treatment liquid, and the post-treatment liquid.

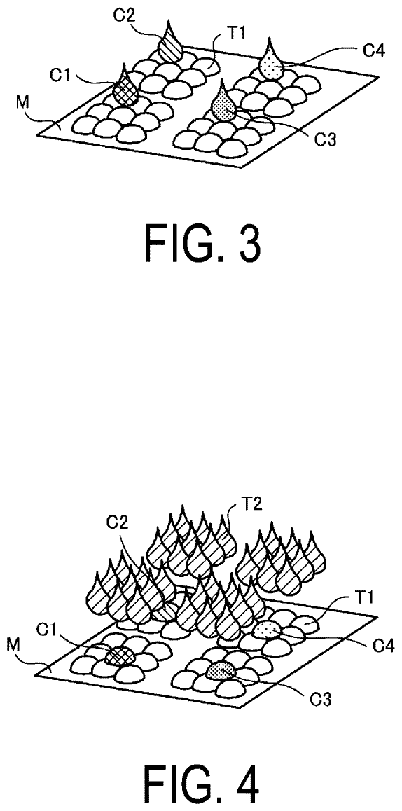

As illustrated in FIG. 2, the printing device 1 first causes the pre-treatment liquid head 21 to discharge a pre-treatment liquid T1 onto the recording medium M. Subsequently, as illustrated in FIG. 3, the printing device 1 causes the first to fourth ink heads 11 to 14 to discharge inks C1 to C4 onto the recording medium M. The inks C1 to C4 are discharged onto the pre-treatment liquid T1 discharged onto the recording medium M. As a result, fixability of the ink C1 to C4 and an aggregation property of a pigment contained in an ink pigment can be enhanced. Note that, here, the example in which all the inks C1 to C4 are discharged is illustrated, but since the inks C1 to C4 to be discharged depend on an image to be printed, all the inks C1 to C4 are not necessarily discharged.

Thereafter, as illustrated in FIG. 4, in the printing device 1, a post-treatment liquid T2 is discharged from the post-treatment liquid head 22 onto the recording medium M. The post-treatment liquid T2 is discharged onto the inks C1 to C4. As a result, fixability and fastness of an ink image drawn on the recording medium M can be enhanced.

Each of the pre-treatment liquid head 21 and the post-treatment liquid head 22, as one head, needs to cover a discharge area of all the inks C1 to C4 discharged from the first to fourth ink heads 11 to 14. The pre-treatment liquid T1 and the post-treatment liquid T2 are discharged in a range wider than landed dots of the inks C1 to C4 in consideration of landing position deviation. Therefore, each of a discharge amount of the pre-treatment liquid T1 from the pre-treatment liquid head 21 and a discharge amount of the post-treatment liquid T2 from the post-treatment liquid head 22 tends to be larger than a discharge amount of each of the inks C1 to C4 from the first to fourth ink heads 11 to 14.

### Configuration Examples of Ink Head and Treatment Liquid Head

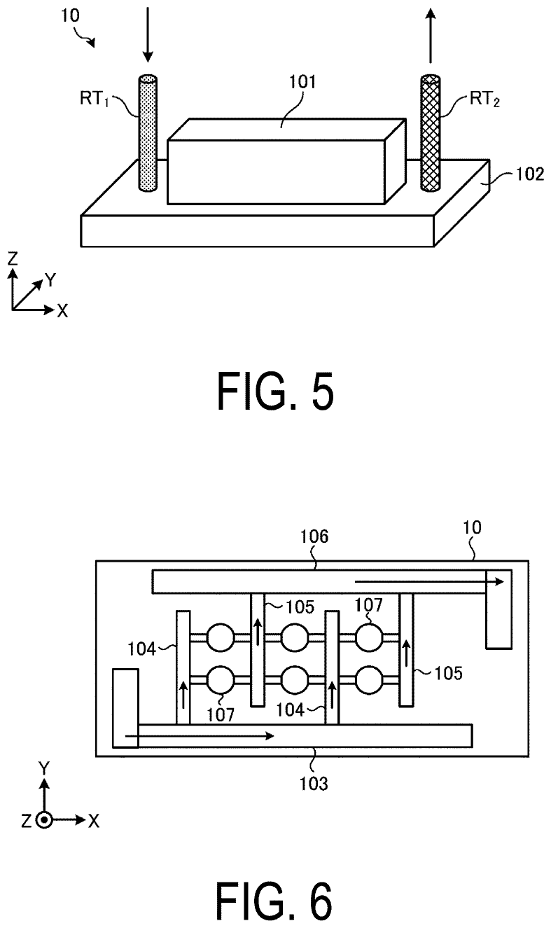

Configuration examples of the ink head 10 and the treatment liquid head 20 will be described. Note that, in the embodiment, the ink head 10 and the treatment liquid head 20 are configured in the same and/or similar manner. Therefore, here, the configuration of the ink head 10 will be described with reference to FIG. 5 to FIG. 8, and description of the configuration of the treatment liquid head 20 will be omitted.

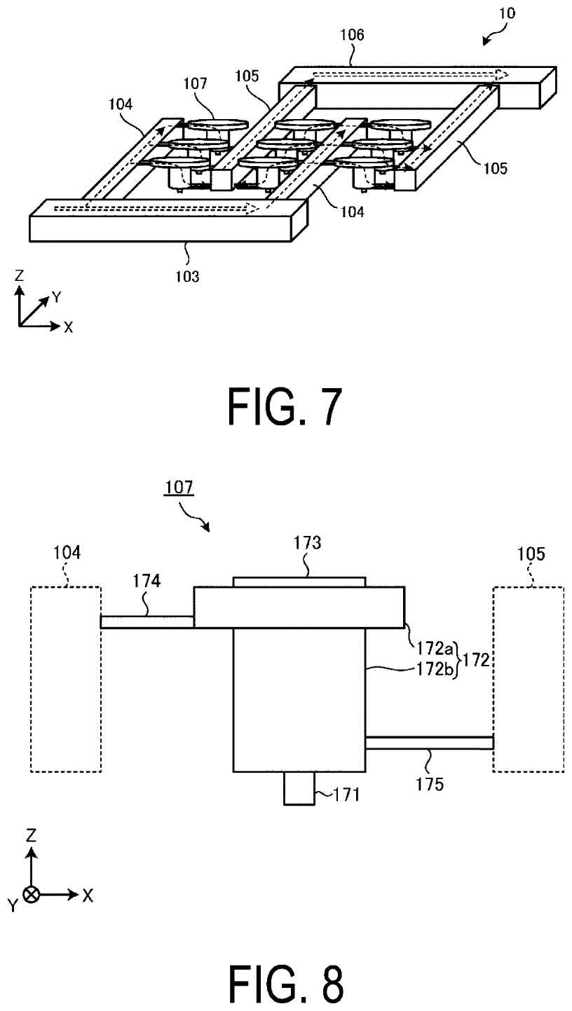

FIG. 5 is a perspective view schematically illustrating an outer appearance configuration of the ink head 10 according to the embodiment. FIG. 6 is a plan view of the ink head 10 according to the embodiment. FIG. 7 is a diagram schematically illustrating a channel inside the ink head 10 according to the embodiment. FIG. 8 is a diagram schematically illustrating a configuration example of an element portion 107 according to the embodiment.

As illustrated in FIG. 5, the ink head 10 includes a housing including a box-shaped member 101 and a substantially plate-shaped member 102. In the housing of the ink head 10, a first channel RT₁ for supplying ink from a first ink circulation unit 311 to an inside of the head and a second channel RT₂ for feeding the ink recovered inside the head back to the first ink circulation unit 311 are installed.

As illustrated in FIG. 6, the ink head 10 includes a supply reservoir 103, a supply manifold 104, a recovery manifold 105, a recovery reservoir 106, and the element portion 107.

The supply reservoir 103 has a long thin shape extending in a longitudinal direction, an X-axis direction here, of the ink head 10, and is connected to the supply manifold 104. The supply reservoir 103 has a channel therein. As illustrated in FIG. 6, a liquid supplied through the first channel RT₁ to the supply reservoir 103 and stored in the channel of the supply reservoir 103 is fed into the supply manifold 104.

The supply manifold 104 has a long thin shape extending in a lateral direction, a Y-axis direction here, of the ink head 10 to near the recovery reservoir 106. The supply manifold 104 internally has a channel that communicates with the channel included in the supply reservoir 103 and with the element portion 107. As illustrated in FIG. 7, the liquid fed from the supply reservoir 103 to the supply manifold 104 is fed from the supply manifold 104 to the element portion 107.

The recovery manifold 105 has a long thin shape extending in the lateral direction of the ink head 10 to near the supply reservoir 103. The recovery manifold 105 internally has a channel that communicates with a channel included in the recovery reservoir 106 and with the element portion 107. As illustrated in FIG. 7, an ink that has not been discharged from the element portion 107 to an outside is fed into the recovery manifold 105.

The recovery reservoir 106 has a long thin shape extending in the longitudinal direction of the ink head 10 and is connected to the recovery manifold 105. The recovery reservoir 106 has the channel therein. As illustrated in FIG. 7, the ink fed from the recovery manifold 105 to the recovery reservoir 106 and stored in the channel of the recovery reservoir 106 is fed back to an ink circulation unit 310 through the second channel RT₂.

As illustrated in FIG. 8, the element portion 107 includes a nozzle 171, a pressurizing chamber 172, and a displacement element 173. The nozzle 171 is a discharge hole that opens in a discharge surface of the ink head 10.

The pressurizing chamber 172 is connected to the nozzle 171. The pressurizing chamber 172 includes a main body portion 172a pressurized at the displacement element 173, and a descender 172b which is a channel connecting the main body portion 172a and the nozzle 171. The pressurizing chamber 172 and the supply manifold 104 are connected through a separate supply channel 174. The ink fed from the supply manifold 104 to the element portion 107 is supplied to the pressurizing chamber 172 through the separate supply channel 174. The pressurizing chamber 172 and the recovery manifold 105 are connected through a separate recovery channel 175. The ink that is not discharged from the nozzle 171 to an outside is recovered from the pressurizing chamber 172 to the recovery manifold 105.

The displacement element 173 is located on a surface of the main body portion 172a of the pressurizing chamber 172 opposite to the descender 172b. The displacement element 173 is an element that deforms in response to a predetermined driving signal. As the displacement element 173, for example, a piezoelectric element or the like may be used. The displacement element 173 causes the pressurizing chamber 172 to discharge an ink droplet from the nozzle 171. That is, when the displacement element 173 deforms, pressures (a positive pressure and a negative pressure) are applied to the pressurizing chamber 172, and the ink droplet is discharged from the nozzle 171. The displacement element 173 is electrically connected to a controller 250 and is controlled at the controller 250.

The element portion 107 having such a configuration suctions the ink from the supply manifold 104 with the negative pressure generated in the pressurizing chamber 172 and causes the suctioned ink to be discharged from the nozzle 171 toward the recording medium M with the positive pressure generated in the pressurizing chamber 172.

The ink circulation unit 310 circulates ink through the ink head 10, specifically, the supply manifold 104, the separate supply channel 174, the pressurizing chamber 172, the separate recovery channel 175, and the recovery manifold 105 of the ink head 10. A treatment liquid circulation unit 320 circulates a treatment liquid through the treatment liquid head 20, specifically, the supply manifold 104, the separate supply channel 174, the pressurizing chamber 172, the separate recovery channel 175, and the recovery manifold 105 of the treatment liquid head 20.

### Configuration Examples of Circulation Device

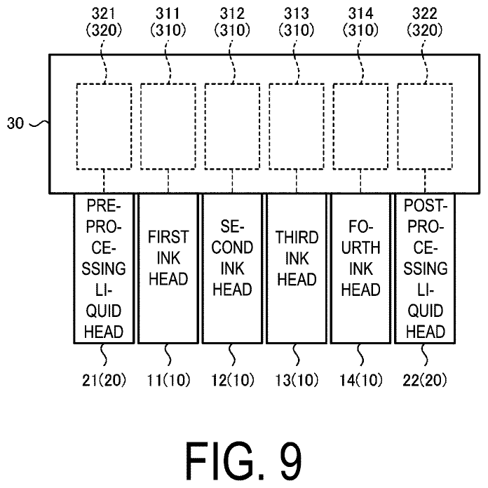

A configuration example of the circulation device 30 will be described with reference to FIG. 9. FIG. 9 is a schematic view illustrating the configuration example of the circulation device 30 according to the embodiment.

As illustrated in FIG. 9, in the embodiment, the circulation device 30 includes a plurality of ink circulation units 310 and a plurality of treatment liquid circulation units 320.

The ink circulation unit 310 circulates ink through the ink head 10 that discharges the ink. Specifically, the circulation device 30 includes a first ink circulation unit 311, a second ink circulation unit 312, a third ink circulation unit 313, and a fourth ink circulation unit 314 as the ink circulation units 310. The first ink circulation unit 311 circulates the ink C1 via the first ink head 11. The second ink circulation unit 312 circulates the ink C2 via the second ink head 12. The third ink circulation unit 313 circulates the ink C3 via the third ink head 13. The fourth ink circulation unit 314 circulates the ink C4 via the fourth ink head 14.

The treatment liquid circulation unit 320 circulates a treatment liquid via the treatment liquid head 20 that discharges the treatment liquid. Specifically, the circulation device 30 includes a pre-treatment liquid circulation unit 321 and a post-treatment liquid circulation unit 322 as the treatment liquid circulation units 320. The pre-treatment liquid circulation unit 321 circulates the pre-treatment liquid T1 via the pre-treatment liquid head 21. The post-treatment liquid circulation unit 322 circulates the post-treatment liquid T2 via the post-treatment liquid head 22.

### Configuration Examples of Ink Circulation Unit and Treatment Liquid Circulation Unit

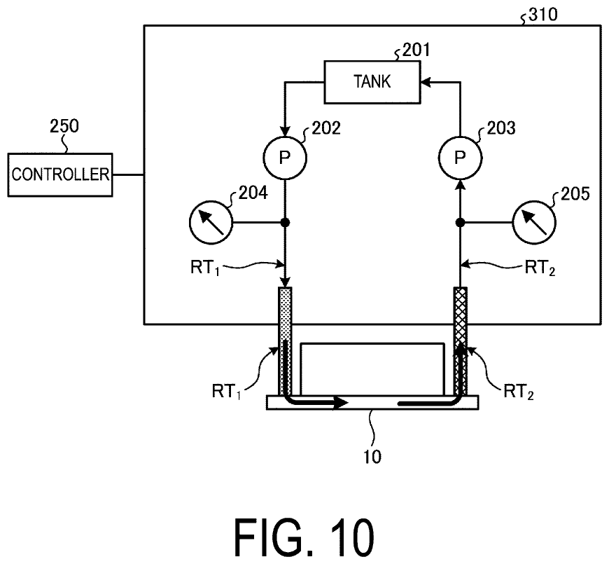

Configuration examples of the ink circulation unit 310 and the treatment liquid circulation unit 320 will be described with reference to FIG. 10. FIG. 10 is a schematic view illustrating a configuration example of the ink circulation unit 310 according to the embodiment. Note that the treatment liquid circulation unit 320 and the ink circulation unit 310 are configured in the same and/or similar manner. Therefore, description of the configuration of the treatment liquid circulation unit 320 will be omitted.

Note that FIG. 10 illustrates an example of the configuration of the treatment liquid circulation unit 320 according to the embodiment, and the configuration need not be particularly limited to the example illustrated in FIG. 10, provided that various functions of the treatment liquid circulation unit 320 according to the embodiment can be realized. FIG. 10 illustrates, in functional blocks, components provided in the treatment liquid circulation unit 320 according to the embodiment and omits a description of other components in general. The components of the treatment liquid circulation unit 320 illustrated in FIG. 10 are functional concepts and are not limited to the example illustrated in FIG. 10, and are not necessarily physically configured as illustrated.

As illustrated in FIG. 10, the ink circulation unit 310 includes a tank 201, a discharge pump 202, a suction pump 203, a first pressure sensor 204, and a second pressure sensor 205, as an example. The ink circulation unit 310 includes the first channel RT₁ and the second channel RT₂.

The first channel RT₁ is a channel causing the tank 201 and the ink head 10 to communicate with each other to cause an ink stored in the tank 201 to flow into the ink head 10. The second channel RT₂ is a channel causing the tank 201 and the ink head 10 to communicate with each other to cause the ink that has flowed into the ink head 10 to return to the tank 201. An ink that is not discharged from the ink head 10 to an outside is sent back to the tank 201 via the second channel RT₂.

The tank 201 stores the ink supplied to the ink head 10. The tank 201 functions as a pool for storing the ink supplied to the ink head 10.

The discharge pump 202 feeds the ink stored in the tank 201 through the first channel RT₁ to the ink head 10. The suction pump 203 feeds, through the second channel RT₂, the ink recovered in the ink head 10 to the tank 201. The discharge pump 202 and the suction pump 203 can each be implemented by a rotary pump such as a gear pump or a displacement pump such as a diaphragm pump.

The first pressure sensor 204 measures, at the discharge pump 202, a pressure of the ink fed from the tank 201 to the ink head 10. The second pressure sensor 205 measures a pressure of the ink that is suctioned from the ink head 10 at the suction pump 203 and fed to the tank 201.

The circulation device 30 includes the controller 250 that controls the ink circulation unit 310 and the treatment liquid circulation unit 320. For example, based on detection values of the first pressure sensor 204 and the second pressure sensor 205, the controller 250 controls the discharge pump 202 and the suction pump 203 such that a pressure difference between the first channel RT₁ which is a supply side and the second channel RT₂ which is a recovery side converges to a predetermined target value. Thus, a circulation flow rate is controlled to be a target flow rate.

The configuration of the ink circulation unit 310 illustrated in FIG. 10 is an example. For example, instead of the first pressure sensor 204 and the second pressure sensor 205, or in addition to the first pressure sensor 204 and the second pressure sensor 205, the ink circulation unit 310 may be provided with a flow rate sensor that detects a flow rate of the liquid supplied to the ink head 10 and a flow rate sensor that detects a flow rate of the ink recovered from the ink head 10. In this case, the controller 250 can control a circulation flow rate based on detection results of these flow rate sensors.

Viscosity of each of the pre-treatment liquid T1, the post-treatment liquid T2, and the inks C1 to C4 depends on temperature. For this reason, compositions of each of the pre-treatment liquid T1, the post-treatment liquid T2, and the inks C1 to C4 are adjusted such that optimum viscosity with respect to an assumed use temperature is obtained, for example.

However, temperature of each of the pre-treatment liquid T1, the post-treatment liquid T2, and the inks C1 to C4 fluctuates due to a heat dissipation effect caused by discharge and circulation and a heat generation effect caused by heat generation of a head driving system.

Here, a heat dissipation amount due to the discharge and circulation and a heat generation amount due to the heat generation of the head driving system are different among the pre-treatment liquid T1, the post-treatment liquid T2, and the inks C1 to C4. For this reason, variation in temperature may occur among the pre-treatment liquid T1, the post-treatment liquid T2, and the inks C1 to C4. When the variation in temperature occurs among the pre-treatment liquid T1, the post-treatment liquid T2, and the inks C1 to C4, the viscosity changes in the pre-treatment liquid T1, the post-treatment liquid T2, and the inks C1 to C4, and thus variation in discharge properties may occur.

Therefore, in the embodiment, in the circulation device 30, the circulation flow rate of the ink in the ink circulation unit 310 and the circulation flow rate of the treatment liquid in the treatment liquid circulation unit 320 are made different from each other to reduce the variation in temperature between the ink and the treatment liquid. The term “the circulation flow rate of the treatment liquid” as used herein refers to the circulation flow rate of the pre-treatment liquid T1 or the circulation flow rate of the post-treatment liquid T2. The embodiment is not limited thereto, the term “the circulation flow rate of the treatment liquid” may be, for example, an average value of the circulation flow rate of the pre-treatment liquid T1 and the circulation flow rate of the post-treatment liquid T2. The term “the circulation flow rate of the ink” may be an average value of the circulation flow rates of the ink C1 to the ink C4, for example. The embodiment is not limited thereto, the term “the circulation flow rate of the ink” may be, for example, a circulation flow rate of an ink having a largest circulation flow rate among the ink C1 to the ink C4.

Specifically, in the embodiment, the circulation device 30 makes the circulation flow rate of the ink and the circulation flow rate of the treatment liquid different from each other such that a magnitude relationship between a sum of a discharge amount and the circulation flow rate of the ink and a sum of a discharge amount and the circulation flow rate of the treatment liquid matches a magnitude relationship between a heat generation amount of the ink head 10 and a heat generation amount of the treatment liquid head 20. Specifically, for example, when the heat generation amount of the ink head 10 is larger than the heat generation amount of the treatment liquid head 20, the circulation device 30 makes the circulation flow rate of the ink and the circulation flow rate of the treatment liquid different from each other such that the sum of the discharge amount and the circulation flow rate of the ink is larger than the sum of the discharge amount and the circulation flow rate of the treatment liquid. On the other hand, when the heat generation amount of the ink head 10 is smaller than the heat generation amount of the treatment liquid head 20, the circulation device 30 makes the circulation flow rate of the ink and the circulation flow rate of the treatment liquid different from each other such that the sum of the discharge amount and the circulation flow rate of the ink is smaller than the sum of the discharge amount and the circulation flow rate of the treatment liquid. As a result, variations in temperature between the ink and the treatment liquid can be reduced.

More specifically, as described above, the discharge amount of the treatment liquid at the treatment liquid head 20 tends to be larger than the discharge amount of the ink at the ink head 10. In other words, the number of element portions 107 driven in the treatment liquid head 20 tends to be larger than the number of element portions 107 driven in the ink head 10. Since the element portion 107 becomes a heat generation source, a heat generation amount becomes larger as the number of driven element portions 107 increases. Therefore, the heat generation amount in the treatment liquid head 20 tends to be larger than the heat generation amount in the ink head 10.

In the embodiment, in the circulation device 30, a supply pressure at the discharge pump 202 and a suction pressure at the suction pump 203 are adjusted such that the circulation flow rate of the treatment liquid in the treatment liquid circulation unit 320 is higher than the circulation flow rate of the ink in the ink circulation unit 310.

Note that the “heat generation amount” here means a heat generation amount estimated from an electrostatic capacitance of the element portion 107, a drive voltage of the element portion 107, the number of element portions 107 to be driven, and the like. In other words, the “heat generation amount” here means a heat generation amount for which a heat dissipation amount due to discharge and circulation of the ink or the treatment liquid is not taken into consideration. Note that in the calculation of the heat generation amount, the “element portion 107” may be read as the “displacement element 173”.

A circulation flow rate in the pre-treatment liquid circulation unit 321 or the post-treatment liquid circulation unit 322 may be compared with, for example, an average value of the circulation flow rates of the inks C1 to C4 in the first to fourth ink circulation units 311 to 314. That is, a circulation flow rate of the pre-treatment liquid T1 in the pre-treatment liquid circulation unit 321 may be higher than the average value of the circulation flow rates of the inks C1 to C4 in the first to fourth ink circulation units 311 to 314. A circulation flow rate of the post-treatment liquid T2 in the post-treatment liquid circulation unit 322 may be higher than the average value of the circulation flow rates of the inks C1 to C4 in the first to fourth ink circulation units 311 to 314.

The circulation flow rate of the pre-treatment liquid T1 in the pre-treatment liquid circulation unit 321 may be different from the circulation flow rate of the post-treatment liquid T2 in the post-treatment liquid circulation unit 322.

To be specific, the circulation flow rate of the pre-treatment liquid T1 and the circulation flow rate of the post-treatment liquid T2 are made different from each other such that a magnitude relationship between a heat generation amount of the pre-treatment liquid head 21 and a heat generation amount of the post-treatment liquid head 22 matches a magnitude relationship between a sum of a discharge amount and a circulation flow rate of the pre-treatment liquid head 21 and a sum of a discharge amount and a circulation flow rate of the post-treatment liquid head 22. Specifically, for example, when the heat generation amount of the pre-treatment liquid head 21 is larger than the heat generation amount of the post-treatment liquid head 22, the circulation device 30 makes the circulation flow rate of the pre-treatment liquid T1 and the circulation flow rate of the post-treatment liquid T2 different from each other such that a sum of the discharge amount and the circulation flow rate of the pre-treatment liquid T1 is larger than a sum of the discharge amount and the circulation flow rate of the post-treatment liquid T2. Conversely, when the heat generation amount of the pre-treatment liquid head 21 is smaller than the heat generation amount of the post-treatment liquid head 22, the circulation device 30 makes the circulation flow rate of the pre-treatment liquid T1 and the circulation flow rate of the post-treatment liquid T2 different from each other such that the sum of the discharge amount and the circulation flow rate of the pre-treatment liquid T1 is smaller than the sum of the discharge amount and the circulation flow rate of the post-treatment liquid T2. As a result, variation in temperature in the pre-treatment liquid T1 and the post-treatment liquid T2 can be reduced.

Here, a discharge amount of the post-treatment liquid T2 to be discharged from one nozzle in the post-treatment liquid head 22 may be set to be smaller than a discharge amount of the pre-treatment liquid T1 to be discharged from one nozzle in the pre-treatment liquid head 21. As will be described later, the treatment liquid head 20 dissipates heat due to discharge of the treatment liquid from the treatment liquid head 20 and circulation of the treatment liquid at the treatment liquid circulation unit 320. Specifically, as the discharge amount of the treatment liquid of the treatment liquid head 20 increases, or as the circulation flow rate of the treatment liquid at the treatment liquid circulation unit 320 increases, a heat dissipation amount of the treatment liquid head 20 increases. Note that this also applies to the ink head 10. Therefore, when the discharge amount of the post-treatment liquid T2 is smaller than the discharge amount of the pre-treatment liquid T1, a heat dissipation amount of the post-treatment liquid head 22 may be smaller than a heat dissipation amount of the pre-treatment liquid head 21. That is, a temperature of the post-treatment liquid T2 may become higher than a temperature of the pre-treatment liquid T1.

In such a case, the circulation flow rate of the post-treatment liquid T2 in the post-treatment liquid circulation unit 322 may be larger than the circulation flow rate of the pre-treatment liquid T1 in the pre-treatment liquid circulation unit 321. Thus, variation in temperature between the pre-treatment liquid T1 and the post-treatment liquid T2 can be reduced.

The circulation flow rates of the inks C1 to C4 at the ink circulation units 310, the circulation flow rate of the pre-treatment liquid T1 at the pre-treatment liquid circulation unit 321, and the circulation flow rate of the post-treatment liquid T2 at the post-treatment liquid circulation unit 322 may be made different from each other such that a magnitude relationship among the heat generation amount of the ink head 10, the heat generation amount of the pre-treatment liquid head 21, and the heat generation amount of the post-treatment liquid head 22 matches a magnitude relationship between the sum of the discharge amount and the circulation flow rate of the ink, the sum of the discharge amount and the circulation flow rate of the pre-treatment liquid head 21, and the sum of the discharge amount and the circulation flow rate of the post-treatment liquid head 22. Specifically, for example, when the magnitude relationship among the heat generation amounts satisfies the heat generation amount of the ink head 10<the heat generation amount of the post-treatment liquid head 22<the heat generation amount of the pre-treatment liquid head 21, the circulation device 30 may make the circulation flow rates of the inks C1 to C4, the circulation flow rate of the pre-treatment liquid T1, and the circulation flow rate of the post-treatment liquid T2 different from each other such that the magnitude relationship among the sums of the discharge amounts and the circulation flow rates satisfies the sum of the discharge amount and the circulation flow rate of the ink<the sum of the discharge amount and the circulation flow rate of the post-treatment liquid T2<the sum of the discharge amount and the circulation flow rate of the pre-treatment liquid T1.

The circulation device 30 may make the circulation flow rates different from each other among the ink C1 to the ink C4. That is, the circulation flow rate of the ink C1 in the first ink circulation unit 311, the circulation flow rate of the ink C2 in the second ink circulation unit 312, the circulation flow rate of the ink C3 in the third ink circulation unit 313, and the circulation flow rate of the ink C4 in the fourth ink circulation unit 314 may be different from each other. The ink C1 is an example of a first ink. The ink C2 is an example of a second ink. In this case, the circulation device 30 makes the circulation flow rates of the respective inks C1 to C4 different from each other such that a magnitude relationship among the heat generation amounts of the respective first to fourth ink heads 11 to 14 matches a magnitude relationship among the sums of the discharge amounts and the circulation flow rates of the respective inks C1 to C4. Specifically, for example, when the magnitude relationship of the heat generation amounts satisfies the heat generation amount of the first ink head 11<the heat generation amount of the second ink head 12<the heat generation amount of the third ink head 13<the heat generation amount of the fourth ink head 14, the circulation device 30 may make the circulation flow rates of the respective inks C1 to C4 such that the magnitude relationship among the sums of the discharge amounts and the circulation flow rates satisfies the sum of the discharge amount and the circulation flow rate of the ink C1<the sum of the discharge amount and the circulation flow rate of the ink C2<the sum of the discharge amount and the circulation flow rate of the ink C3<the sum of the discharge amount and the circulation flow rate of the ink C4. Accordingly, variation in temperature among the ink C1 to the ink C4 can be reduced.

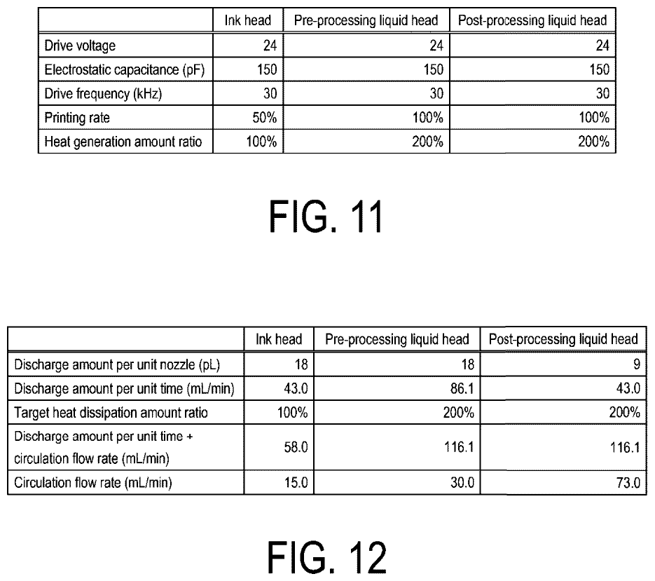

An example of a setting method of a circulation flow rate in the circulation device 30 according to the embodiment will be described with reference to FIG. 11 and FIG. 12. First, with reference to FIG. 11, a method of calculating the heat generation amounts of the ink head 10, the pre-treatment liquid head 21, and the post-treatment liquid head 22 will be described. FIG. 11 is a table illustrating a drive voltage, an electrostatic capacitance, and a drive frequency of the element portion 107, a printing rate per unit image, and a heat generation amount ratio in each of the ink head 10, the pre-treatment liquid head 21, and the post-treatment liquid head 22.

A heat generation amount Q_{E} when one pulse of a drive voltage is applied to one element portion 107 in each head can be expressed by Q_{E}=CV². Here, “C” is the electrostatic capacitance of the element portion 107, and “V” is the drive voltage of the element portion 107. The electrostatic capacitance of the element portion 107 may be measured by, for example, bringing a tester into contact with the element portion 107. In this case, a result obtained by measuring an electrostatic capacitance of any one of the element portions 107 may be used, or electrostatic capacitances of a plurality of element portions 107 may be measured to use an average value thereof. As a drive voltage of the element portion 107, for example, a median rated voltage may be used, or actual measurement may be performed.

In the above expression, it is assumed that the number of pulses constituting one pixel is one. A drive voltage and an electrostatic capacitance of the ink head 10 may be an average value of drive voltages and an average value of electrostatic capacitances of the first to fourth ink heads 11 to 14.

FIG. 11 shows an example of a case in which the ink head 10, the pre-treatment liquid head 21, and the post-treatment liquid head 22 have the same drive voltage and the same electrostatic capacitance for ease of understanding. The embodiment is not limited thereto, the drive voltage and the electrostatic capacitance of the element portion 107 may be different among the ink head 10, the pre-treatment liquid head 21, and the post-treatment liquid head 22.

The heat generation amount Q_{T} of each of the ink head 10, the pre-treatment liquid head 21, and the post-treatment liquid head 22 can be expressed by Q_{T}=Q_{E}×the drive frequency×the total number of element portions×the printing rate. The “drive frequency” is the number of pulses applied to the element portion 107 per second. The “total number of element portions” is the number of all the element portions 107 included in each head. The “printing rate” is expressed by the number of discharge pixels/(the number of discharge pixels+the number of non-discharge pixels) in a unit image. In the example illustrated in FIG. 11, the printing rate of each of the pre-treatment liquid head 21 and the post-treatment liquid head 22 is “100%”. This means that the pre-treatment liquid T1 and the post-treatment liquid T2 are discharged to all pixels in a unit image, in other words, the pre-treatment liquid T1 and the post-treatment liquid T2 are discharged to the entire unit image. A printing rate of ink head 10 may be, for example, an average value of printing rates of the first to fourth ink heads 11 to 14.

In the example illustrated in FIG. 11, the drive voltage, the electrostatic capacitance, and the drive frequency are the same among the ink head 10, the pre-treatment liquid head 21, and the post-treatment liquid head 22. In the example illustrated in FIG. 11, the printing rate of the ink head 10 is 50%, and the printing rate of each of the pre-treatment liquid head 21 and the post-treatment liquid head 22 is 100%. Here, the printing rate of the ink head 10 is, for example, the average printing rate of the first to fourth ink heads 11 to 14. Therefore, a heat generation amount ratio among the ink head 10, the pre-treatment liquid head 21, and the post-treatment liquid head 22 is 100%: 200%: 200%, that is, 1:2:2 when the heat generation amount of the ink head 10 is 100%. In other words, the heat generation amount of each of the pre-treatment liquid head 21 and the post-treatment liquid head 22 is twice the heat generation amount of the ink head 10.

With reference to FIG. 12, a description will be given of a method of calculating a heat dissipation amount of each of the ink head 10, the pre-treatment liquid head 21, and the post-treatment liquid head 22. FIG. 12 is a table illustrating a discharge amount per unit nozzle, a discharge amount per unit time, a target heat dissipation amount ratio, the discharge amount per unit time+a circulation flow rate, and the circulation flow rate in each of the ink head 10, the pre-treatment liquid head 21, and the post-treatment liquid head 22.

The heat dissipation amount of each head is proportional to a sum of the discharge amount per unit time and the circulation flow rate. The circulation flow rate is an amount circulated through the head per unit time. The discharge amount per unit time can be expressed by a consumption amount of the ink or the treatment liquid/a time required for drawing. The consumption amount of the ink or the treatment liquid can be specified by, for example, measuring a consumption amount of the ink or the treatment liquid when a unit image is printed, that is, a decrease amount of the ink or the treatment liquid in the tank 201. The consumption amount of ink may be an average value of consumption amounts of the respective inks C1 to C4. The time required for drawing can be specified by actually measuring a time required for printing the unit image. The time required for drawing is a time from a start to an end of a printing process and is the same for each head.

In the example illustrated in FIG. 12, the amount “9 pL” of the post-treatment liquid T2 discharged from one nozzle of the post-treatment liquid head 22 at the time of applying one pulse is smaller than the amount “18 pL” of the pre-treatment liquid T1 discharged from one nozzle of the pre-treatment liquid head 21 at the time of applying one pulse. Therefore, although the printing rates of both the pre-treatment liquid head 21 and the post-treatment liquid head 22 are 100%, the discharge amount per unit time “43 mL/min” in the post-treatment liquid head 22 is smaller than the discharge amount per unit time “86.1 mL/min” in the pre-treatment liquid head 21. In other words, a heat dissipation amount caused by discharging the post-treatment liquid T2 in the post-treatment liquid head 22 is smaller than a heat dissipation amount caused by discharging the pre-treatment liquid T1 in the pre-treatment liquid head 21.

The target heat dissipation amount ratio among the ink head 10, the pre-treatment liquid head 21, and the post-treatment liquid head 22 is set to match the heat generation amount ratio among the ink head 10, the pre-treatment liquid head 21, and the post-treatment liquid head 22. That is, as illustrated in FIG. 11, when the heat generation amount ratio among the ink head 10, the pre-treatment liquid head 21, and the post-treatment liquid head 22 is 100%: 200%: 200%, the target heat dissipation amount ratio among the ink head 10, the pre-treatment liquid head 21, and the post-treatment liquid head 22 is also set to 100%: 200%: 200%.

In the circulation device 30, the circulation flow rate for each head is set such that a ratio of sums of the discharge amounts per unit time and the circulation flow rates among the ink head 10, the pre-treatment liquid head 21, and the post-treatment liquid head 22 matches the target heat dissipation amount ratio among the ink head 10, the pre-treatment liquid head 21, and the post-treatment liquid head 22.

For example, when the circulation flow rate “15 mL/min” of the ink head 10 is used as a reference, the sum of the discharge amount per unit time and the circulation flow rate in each of the pre-treatment liquid head 21 and the post-treatment liquid head 22 is set to 116.1 mL/min, which is twice the sum of the discharge amount per unit time and the circulation flow rate in the ink head 10 “58.0 mL/min”.

The discharge amount per unit time in the pre-treatment liquid head 21 is 86.1 mL/min. For this reason, the circulation flow rate of the pre-treatment liquid T1 in the pre-treatment liquid head 21 is set to 116.1-86.1=30.0 mL/min. The discharge amount per unit time in the post-treatment liquid head 22 is 43.0 mL/min. Therefore, the circulation flow rate of the post-treatment liquid T2 in the post-treatment liquid head 22 is set to 116.1-43.0=73.0 mL/min.

As described above, in the embodiment, in the circulation device 30, the circulation flow rates of the ink head 10 and the treatment liquid head 20 are made different from each other such that the heat dissipation amount ratio between the ink head 10 and the treatment liquid head 20 is made close to the heat generation amount ratio between the ink head 10 and the treatment liquid head 20. Accordingly, variation in temperature among the inks C1 to C4 and the treatment liquid can be reduced.

In the embodiment, in the circulation device 30, the circulation flow rates are made different between the pre-treatment liquid head 21 and the post-treatment liquid head 22. Thus, variations in temperature between the pre-treatment liquid T1 and the post-treatment liquid T2 can be reduced.

Although the example of the case in which the circulation flow rates of the inks C1 to C4 are set to the same value among the first to fourth ink heads 11 to 14 has been described here, the circulation flow rates of the inks C1 to C4 may be made different from each other among the first to fourth ink heads 11 to 14. In this case, the heat generation amount ratio among the first to fourth ink heads 11 to 14 may be calculated, and the circulation flow rates of the first to fourth ink heads 11 to 14 may be individually set such that a ratio of the sums of the discharge amounts per unit time and the circulation flow rates matches the heat generation amount ratio among the first to fourth ink heads 11 to 14.

The controller 250 controls the circulation flow rate of the ink in the ink circulation unit 310 and the circulation flow rate of the treatment liquid in the treatment liquid circulation unit 320 in accordance with preset information.

For example, the controller 250 may control the circulation flow rate of the ink and the circulation flow rate of the treatment liquid such that the magnitude relationship between the heat generation amount of the ink head 10 and the heat generation amount of the treatment liquid head 20 matches the magnitude relationship between the sum of the discharge amount and the circulation flow rate of the ink and the sum of the discharge amount and the circulation flow rate of the treatment liquid.

The controller 250 may control the circulation flow rate of the ink and the circulation flow rate of the treatment liquid such that the circulation flow rate of the treatment liquid in the treatment liquid circulation unit 320 is higher than the circulation flow rate of the ink in the ink circulation unit 310.

The controller 250 may control the circulation flow rate of the pre-treatment liquid and the circulation flow rate of the post-treatment liquid such that the circulation flow rate of the pre-treatment liquid in the pre-treatment liquid circulation unit 321 and the circulation flow rate of the post-treatment liquid in the post-treatment liquid circulation unit 322 are different from each other.

The controller 250 may control the circulation flow rate of the pre-treatment liquid and the circulation flow rate of the post-treatment liquid such that the magnitude relationship between the heat generation amount of the pre-treatment liquid head 21 and the heat generation amount of the post-treatment liquid head 22 matches the magnitude relationship between the sum of the discharge amount and the circulation flow rate of the pre-treatment liquid head 21 and the sum of the discharge amount and the circulation flow rate of the post-treatment liquid head 22.

The controller 250 may control the circulation flow rate of the pre-treatment liquid and the circulation flow rate of the post-treatment liquid such that the circulation flow rate of the post-treatment liquid in the post-treatment liquid circulation unit 322 is higher than the circulation flow rate of the pre-treatment liquid in the pre-treatment liquid circulation unit 321.

The controller 250 may control the circulation flow rate of the pre-treatment liquid and the circulation flow rate of the ink such that the circulation flow rate of the pre-treatment liquid in the pre-treatment liquid circulation unit 321 is higher than the circulation flow rate of the ink in the ink circulation unit 310. The circulation flow rate of the pre-treatment liquid may be compared with, for example, the average value of the circulation flow rates of the ink C1 to the ink C4. The circulation flow rate of the pre-treatment liquid may be compared with the circulation flow rate of the ink having the largest circulation flow rate among the ink C1 to the ink C4, for example.

The controller 250 may control the circulation flow rate of the post-treatment liquid and the circulation flow rate of the ink such that the circulation flow rate of the post-treatment liquid in the post-treatment liquid circulation unit 322 is higher than the circulation flow rate of the ink in the ink circulation unit 310. The circulation flow rate of the post-treatment liquid may be compared with, for example, the average value of the circulation flow rates of the ink C1 to the ink C4. The circulation flow rate of the post-treatment liquid may be compared with the circulation flow rate of the ink having the largest circulation flow rate among the ink C1 to the ink C4, for example.

The controller 250 may control the circulation flow rate of the ink, the circulation flow rate of the pre-treatment liquid, and the circulation flow rate of the post-treatment liquid such that the magnitude relationship among the heat generation amount of the ink head 10, the heat generation amount of the pre-treatment liquid head 21, and the heat generation amount of the post-treatment liquid head 22 matches the magnitude relationship among the sum of the discharge amount and the circulation flow rate of the ink, the sum of the discharge amount and the circulation flow rate of the pre-treatment liquid head 21, and the sum of the discharge amount and the circulation flow rate of the post-treatment liquid head 22.

The controller 250 may control circulation flow rates of inks in the plurality of ink circulation units 310 such that the circulation flow rates of the inks in the plurality of ink circulation units 310 are different from each other.

The controller 250 may control circulation flow rate of inks in the plurality of ink heads 10 such that a magnitude relationship among heat generation amounts of the plurality of ink heads 10 matches a magnitude relationship between sums of the discharge amounts and the circulation flow rates of the inks in the plurality of ink heads 10.

### Other Embodiments

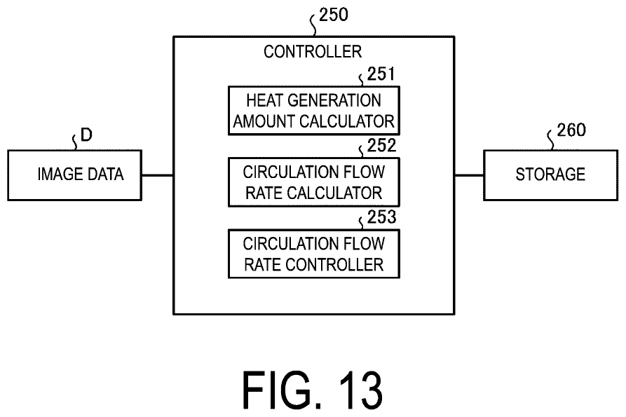

In the above-described embodiment, the case where the circulation flow rate of each head is set in advance, that is, the case where the circulation flow rate is constant regardless of an image to be printed has been described. The embodiment is not limited thereto, the circulation flow rate of each head may be set for each image to be printed. An example of the case will be described with reference to FIG. 13.

FIG. 13 is a block diagram illustrating a functional configuration of the controller 250 according to another embodiment. Note that the controller 250 is not limited to be configured as in the example illustrated in FIG. 13, and is not necessarily required to be physically configured as the illustration. For example, the specific form of distribution and integration of each of the functional blocks is not limited to that illustrated, and all or a portion thereof can be functionally or physically distributed and integrated in any unit, depending on various loads, usage conditions, and the like.

In the other embodiment, the controller 250 controls, based on image data D of a recording medium, the circulation flow rate of each of the inks C1 to C4 in the ink circulation unit 310 and the circulation flow rate of the treatment liquid in the treatment liquid circulation unit 320. As illustrated in FIG. 13, the controller 250 includes a heat generation amount calculator 251, a circulation flow rate calculator 252, and a circulation flow rate controller 253.

When the image data D of the recording medium is acquired, the heat generation amount calculator 251 calculates the heat generation amount of the ink head 10 and the heat generation amount of the treatment liquid head 20 based on the acquired image data D. Here, the circulation device 30 includes a storage 260. For each of the first to fourth ink heads 11 to 14, the pre-treatment liquid head 21, and the post-treatment liquid head 22, the storage 260 stores the drive voltage, the electrostatic capacitance, and the drive frequency of the element portion 107, and the number of element portions 107 (in other words, the number of nozzles). The heat generation amount calculator 251 calculates a printing rate based on the acquired image data D. The heat generation amount calculator 251 calculates an average heat generation amount of the ink head 10, a heat generation amount of the pre-treatment liquid head 21, and a heat generation amount of the post-treatment liquid head 22 based on the calculated printing rate, and the information stored in the storage 260. The heat generation amount calculator 251 calculates the heat generation amount ratio among the ink head 10, the pre-treatment liquid head 21, and the post-treatment liquid head 22.

The circulation flow rate calculator 252 calculates the circulation flow rates of the inks C1 to C4 and the circulation flow rate of the treatment liquid. Specifically, the storage 260 stores the discharge amount per unit nozzle for each of the first to fourth ink heads 11 to 14, the pre-treatment liquid head 21, and the post-treatment liquid head 22. The circulation flow rate calculator 252 calculates an average consumption amount of the inks C1 to C4 required to draw an image on the recording medium, a consumption amount of the pre-treatment liquid T1, and a consumption amount of the post-treatment liquid T2 based on the acquired image data D and the discharge amount per unit nozzle stored in the storage 260. The circulation flow rate calculator 252 calculates a time required to draw the image of the recording medium based on the acquired image data D. The circulation flow rate calculator 252 calculates an average discharge amount of the inks C1 to C4, the discharge amount of the pre-treatment liquid T1, and the discharge amount of the post-treatment liquid T2 in a unit time based on the calculated consumption amounts and time.

The circulation flow rate calculator 252 calculates the circulation flow rates of the inks C1 to C4, the pre-treatment liquid T1, and the post-treatment liquid T2 such that a ratio of a sum of the average discharge amount and a circulation flow rate of the inks C1 to C4, a sum of the discharge amount and the circulation flow rate of the pre-treatment liquid T1, and a sum of the discharge amount and the circulation flow rate of the post-treatment liquid T2 matches the heat generation amount ratio calculated at the heat generation amount calculator 251.

The circulation flow rate controller 253 controls the circulation flow rate for each of the ink head 10, the pre-treatment liquid head 21, and the post-treatment liquid head 22 using the circulation flow rate calculated at the circulation flow rate calculator 252 as a target flow rate. For example, based on detection values of the first pressure sensor 204 and the second pressure sensor 205, the circulation flow rate controller 253 controls the discharge pump 202 and the suction pump 203 such that a pressure difference between the first channel RT₁ as the supply side and the second channel RT₂ as the recovery side converges to the circulation flow rate calculated at the circulation flow rate calculator 252. Thus, a circulation flow rate is controlled to be a target flow rate.

As described above, in the other embodiment, the controller 250 may control, based on image data of an image to be drawn on the recording medium M, the circulation flow rates of the inks C1 to C4 in the ink circulation units 310 and the circulation flow rates of the treatment liquids in the treatment liquid circulation units 320.

Note that although the example in which the circulation flow rates of the inks C1 to C4 are set to the same value among the first to fourth ink heads 11 to 14 has been described here, the circulation flow rates of the inks C1 to C4 may be made different among the first to fourth ink heads 11 to 14. In this case, the controller 250 may calculate the heat generation amount ratio among the first to fourth ink heads 11 to 14, and calculate the circulation flow rates of the first to fourth ink heads 11 to 14 such that the ratio of the sums of the discharge amounts per unit time and the circulation flow rates among the first to fourth ink heads 11 to 14 matches the heat generation amount ratio.

As described above, in the embodiment, the circulation device (as an example, the circulation device 30) includes the ink circulation units (as an example, the first to fourth ink circulation units 311 to 314) and the treatment liquid circulation units (as an example, the pre-treatment liquid circulation unit 321 and the post-treatment liquid circulation unit 322). The ink circulation units circulate the inks via the ink heads (as an example, the first to fourth ink heads 11 to 14) that discharge the inks (as an example, the inks C1 to C4). The treatment liquid circulation units circulate the treatment liquids via the treatment liquid heads (as an example, the pre-treatment liquid head 21 and the post-treatment liquid head 22) that discharge the non-color-developing treatment liquids (as an example, the pre-treatment liquid T1 and the post-treatment liquid T2). In the embodiment, in the circulation device, the circulation flow rate of the ink in the ink circulation unit is different from the circulation flow rate of the treatment liquid in the treatment liquid circulation unit. Therefore, in the embodiment, according to the circulation device, variation in temperature between the ink and the treatment liquid can be reduced.

Embodiments have been described in order to fully and clearly disclose the technique according to the appended claims. However, the appended claims are not to be limited to the embodiments described above, and should be configured to embody all variations and alternative configurations that a person skilled in the art may make within the fundamental matter set forth in the present description.

1. A circulation device, comprising:
an ink circulation unit configured to circulate ink via an ink head for discharging the ink; and
a treatment liquid circulation unit configured to circulate non-color-developing treatment liquid via a treatment liquid head for discharging the treatment liquid, wherein
a circulation flow rate of the ink in the ink circulation unit is different from a circulation flow rate of the treatment liquid in the treatment liquid circulation unit.

2. The circulation device according to claim 1, wherein
a magnitude relationship between a heat generation amount of the ink head and a heat generation amount of the treatment liquid head matches a magnitude relationship between a sum of a discharge amount and a circulation flow rate of the ink and a sum of a discharge amount and a circulation flow rate of the treatment liquid.

3. The circulation device according to claim 1, wherein
the circulation flow rate of the treatment liquid in the treatment liquid circulation unit is higher than the circulation flow rate of the ink in the ink circulation unit.

4. The circulation device according to claim 3, further comprising a plurality of the ink circulation units, wherein
the circulation flow rate of the treatment liquid in the treatment liquid circulation unit is higher than an average value of the circulation flow rate of the ink in the plurality of ink circulation units.

5.-6. (canceled)

7. The circulation device according to claim 2, wherein
the ink head and the treatment liquid head comprise a plurality of element portions comprising a nozzle, a pressurizing chamber connected to the nozzle, and a displacement element for applying pressure to the pressurizing chamber,
a heat generation amount of the ink head is calculated based on an electrostatic capacitance of the element portion comprised in the ink head, a drive voltage of the element portion comprised in the ink head, a drive frequency of the element portion comprised in the ink head, the number of element portions comprised in the ink head, and a printing rate of the ink head in a unit image, and
a heat generation amount of the treatment liquid head is calculated based on an electrostatic capacitance of the element portion comprised in the treatment liquid head, a drive voltage of the element portion comprised in the treatment liquid head, a drive frequency of the element portion comprised in the treatment liquid head, the number of the element portions comprised in the treatment liquid head, and a printing rate of the treatment liquid head in a unit image.

8. The circulation device according to claim 1, wherein
the treatment liquid comprises:
a pre-treatment liquid configured to be discharged before the ink is discharged; and
a post-treatment liquid configured to be discharged after the ink is discharged.

9. The circulation device according to claim 8, wherein
the treatment liquid circulation unit comprises:
a pre-treatment liquid circulation unit configured to circulate the pre-treatment liquid via a pre-treatment liquid head being the treatment liquid head for discharging the pre-treatment liquid; and
a post-treatment liquid circulation unit configured to circulate the post-treatment liquid via a post-treatment liquid head being the treatment liquid head for discharging the post-treatment liquid, and
a circulation flow rate of the pre-treatment liquid in the pre-treatment liquid circulation unit is different from a circulation flow rate of the post-treatment liquid in the post-treatment liquid circulation unit.

10. The circulation device according to claim 9, wherein
a magnitude relationship between a heat generation amount of the pre-treatment liquid head and a heat generation amount of the post-treatment liquid head matches a magnitude relationship between a sum of a discharge amount and a circulation flow rate of the pre-treatment liquid head and a sum of a discharge amount and a circulation flow rate of the post-treatment liquid head.

11. The circulation device according to claim 9, wherein
the circulation flow rate of the post-treatment liquid in the post-treatment liquid circulation unit is higher than the circulation flow rate of the pre-treatment liquid in the pre-treatment liquid circulation unit.

12. The circulation device according to claim 9, wherein
the circulation flow rate of the pre-treatment liquid in the pre-treatment liquid circulation unit is higher than the circulation flow rate of the ink in the ink circulation unit.

13. The circulation device according to claim 9, wherein
the circulation flow rate of the post-treatment liquid in the post-treatment liquid circulation unit is higher than the circulation flow rate of the ink in the ink circulation unit.

14. The circulation device according to claim 9, wherein
a magnitude relationship among a heat generation amount of the ink head, a heat generation amount of the pre-treatment liquid head, and a heat generation amount of the post-treatment liquid head matches a magnitude relationship among a sum of a discharge amount and a circulation flow rate of the ink, a sum of a discharge amount and a circulation flow rate of the pre-treatment liquid head, and a sum of a discharge amount and a circulation flow rate of the post-treatment liquid head.

15. The circulation device according to claim 1, wherein
the ink comprises:
a first ink; and
a second ink different from the first ink in color,
the ink circulation unit comprises:
a first ink circulation unit configured to circulate the first ink via a first ink head being the ink head for discharging the first ink; and
a second ink circulation unit configured to circulate the second ink via a second ink head being the ink head for discharging the second ink, and
a circulation flow rate of the first ink in the first ink circulation unit is different from a circulation flow rate of the second ink in the second ink circulation unit.

16. The circulation device according to claim 15, wherein
a magnitude relationship between a heat generation amount of the first ink head and a heat generation amount of the second ink head matches a magnitude relationship between a sum of a discharge amount and a circulation flow rate of the first ink and a sum of a discharge amount and a circulation flow rate of the second ink.

17. The circulation device according to claim 1, further comprising a controller configured to control the circulation flow rate of the ink in the ink circulation unit and the circulation flow rate of the treatment liquid in the treatment liquid circulation unit.

18. The circulation device according to claim 17, wherein
the controller calculates a heat generation amount of the ink head, a heat generation amount of the treatment liquid head, a discharge amount of the ink, a discharge amount of the treatment liquid, and a time required for drawing, and calculates, based on a result of the calculation, a circulation flow rate of the ink in the ink circulation unit and a circulation flow rate of the treatment liquid in the treatment liquid circulation unit.

19. The circulation device according to claim 18, wherein
the controller calculates a circulation flow rate of the ink in the ink circulation unit and a circulation flow rate of the treatment liquid in the treatment liquid circulation unit such that a magnitude relationship between a heat generation amount of the ink head and a heat generation amount of the treatment liquid head matches a magnitude relationship between a sum of a discharge amount and a circulation flow rate of the ink and a sum of a discharge amount and a circulation flow rate of the treatment liquid.

20. The circulation device according to claim 18, wherein
the controller calculates a circulation flow rate of the ink in the ink circulation unit and a circulation flow rate of the treatment liquid in the treatment liquid circulation unit such that a ratio of a sum of a discharge amount and a circulation flow rate of the ink and a sum of a discharge amount and a circulation flow rate of the treatment liquid matches a ratio of a heat generation amount of the ink head and a heat generation amount of the treatment liquid head.

21. A circulation device, comprising:
a pre-treatment liquid circulation unit configured to circulate a non-color-developing pre-treatment liquid discharged before ink is discharged, via a pre-treatment liquid head for discharging the pre-treatment liquid; and
a post-treatment liquid circulation unit configured to circulate a non-color-developing post-treatment liquid discharged after the ink is discharged, via a post-treatment liquid head for discharging the post-treatment liquid, wherein
a circulation flow rate of the pre-treatment liquid in the pre-treatment liquid circulation unit is different from a circulation flow rate of the post-treatment liquid in the post-treatment liquid circulation unit.

22. A printing device, comprising:
a transporter configured to transport a recording medium; and
the circulation device according to any one of claims 1 to 21.

23.-26. (canceled)
